(19) United States
(12) Patent Application Publication
(10) Pub. No.: US 2025/0044429 A1
(43) Pub. Date: Feb. 6, 2025

(54) LIDAR SENSOR WITH CLEANING RAIL

(71) Applicant: Continental Autonomous Mobility US, LLC, Auburn Hills, MI (US)

(72) Inventor: Paul Vranjes, Santa Barbara, CA (US)

(73) Assignee: Continental Autonomous Mobility US, LLC, Auburn Hills, MI (US)

(21) Appl. No.: 18/229,908

(22) Filed: Aug. 3, 2023

(51) Int. Cl. G01S 7/497; G01S 7/481; G01S 17/931

(52) U.S. Cl. CPC G01S 7/497; G01S 7/4813; G01S 17/931; G01S 2007/4977

(57) ABSTRACT

A LiDAR sensor includes a casing, a window supported by the casing, a light detector having a field of view, and a light emitter having a field of illumination aimed at the field of view. At least one of the light detector or the light emitter is in the casing and aimed through the window. A fluid line is in the casing. A cleaning rail is moveable relative to the casing between a retracted position and an extended position. The cleaning rail is slidably received in the fluid line and slidable relative to the fluid line between the retracted position and the extended position. The cleaning rail has nozzles in fluid communication with the fluid line. The nozzles are aimed at the window in the extended position. The cleaning rail has a rod slidably received in the fluid line and an arm extending transverse to the rod along the window. The arm has the nozzles. A light source is on the rod. The light source is aimed at the window in the extended position. An image sensor is aimed at the window.

### BACKGROUND

A LiDAR (Light Detection And Ranging) sensor, e.g., a solid-state LiDAR sensor includes a photodetector, or an array of photodetectors, that is fixed in place relative to a carrier, e.g., a vehicle. Light is emitted into the field of view of the photodetector and the photodetector detects light that is reflected by an object in the field of view, conceptually modeled as a packet of photons. For example, a Flash LiDAR sensor emits pulses of light, e.g., laser light, into the entire field of view. The detection of reflected light is used to generate a three-dimensional (3D) environmental map of the surrounding environment. The time of flight of reflected photons detected by the photodetector is used to determine the distance of the object that reflected the light.

The LiDAR sensor may be mounted on a vehicle to detect objects in the environment surrounding the vehicle and to detect distances of those objects for environmental mapping. The output of the LiDAR sensor may be used, for example, to autonomously or semi-autonomously control operation of the vehicle, e.g., propulsion, braking, steering, etc. Specifically, the LiDAR sensor may be a component of or in communication with an advanced driver-assistance system (ADAS) of the vehicle.

### BRIEF DESCRIPTION OF THE DRAWINGS

FIG. 1 is a perspective view of a vehicle including a LiDAR sensor.

FIG. 2 is a block diagram of the LiDAR sensor and the vehicle.

FIG. 3 is a schematic view of the LiDAR sensor.

FIG. 4 is a perspective view of the LiDAR sensor with a cleaning rail in a retracted position.

FIG. 5 is the perspective view of FIG. 4 with a casing in broken lines to show fluid lines and the cleaning rail.

FIG. 6 is a perspective view of the LiDAR sensor with a cleaning rail in an extended position.

FIG. 7 is a bottom view of the LiDAR sensor with the cleaning rail in the retracted position.

FIG. 8 is a bottom view of the LiDAR sensor with the cleaning rail in the extended position.

FIG. 9 is a perspective view of one example of the cleaning rail.

FIG. 10 is a perspective view of another example of the cleaning rail.

FIG. 11 is a perspective view of another example of the cleaning rail.

FIG. 12 is a schematic view of a portion of one example of the LiDAR sensor in cross-section.

FIG. 13 is a schematic view of a portion of another example of the LiDAR sensor in cross-section.

### DETAILED DESCRIPTION

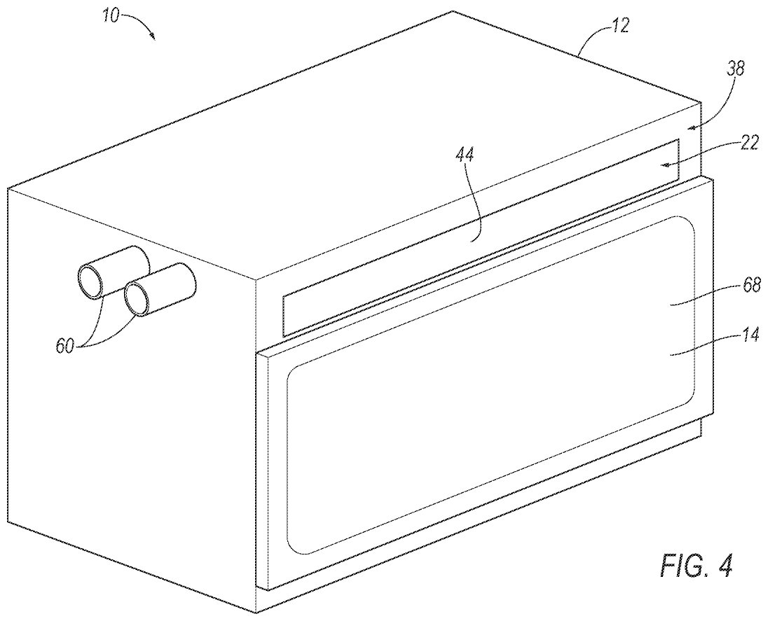

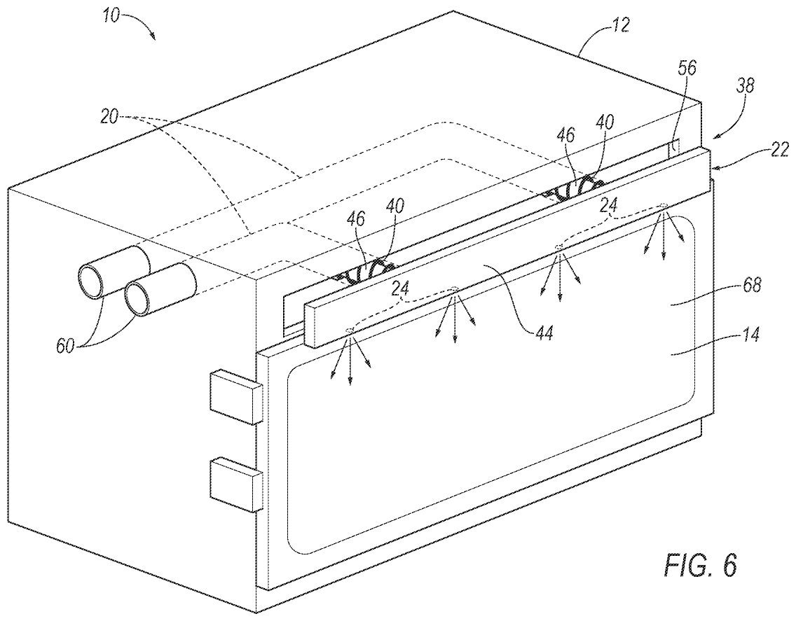

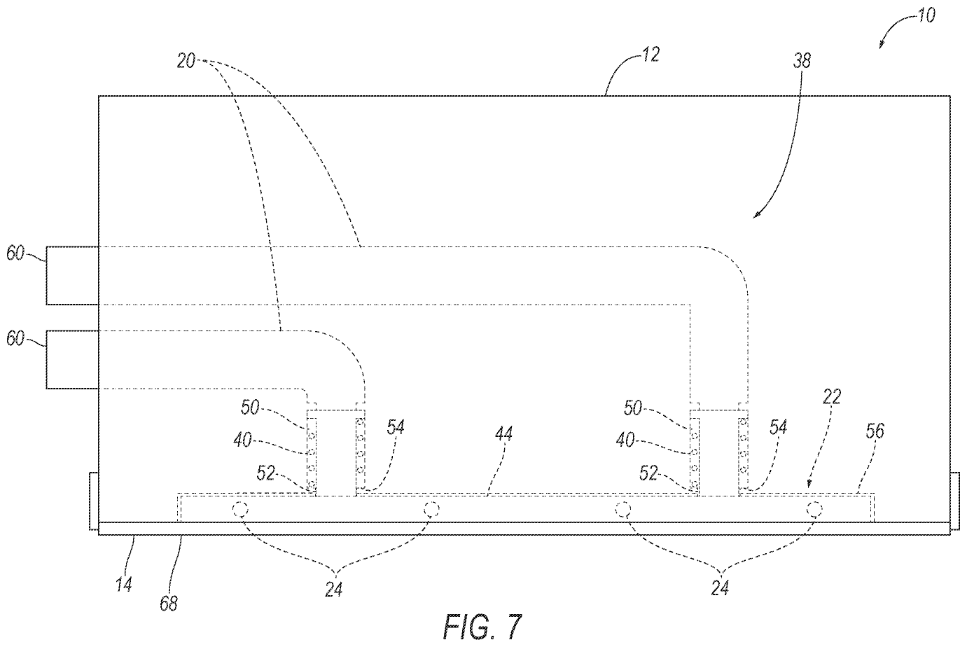

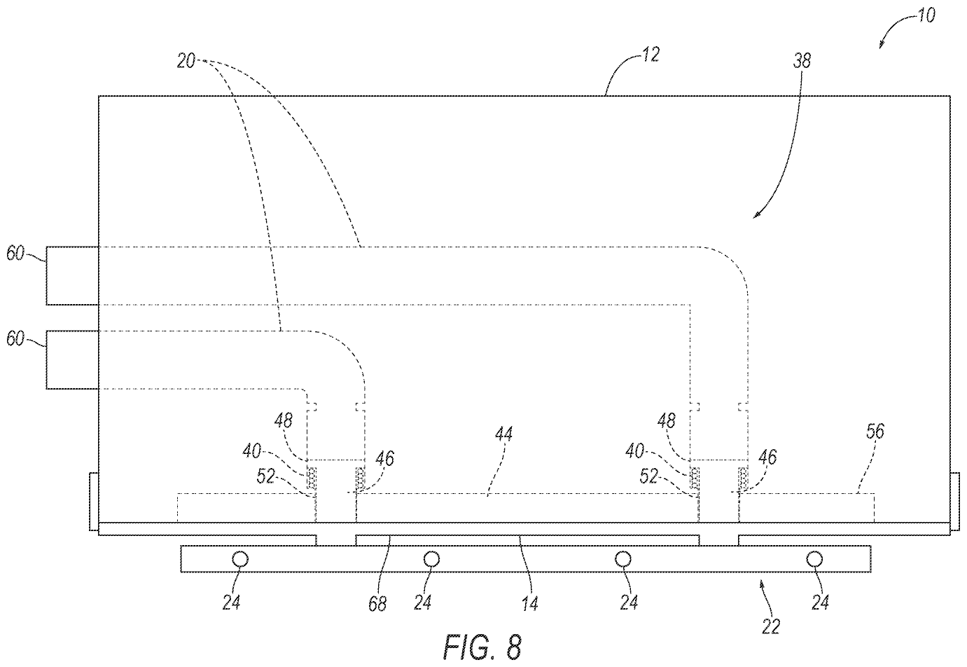

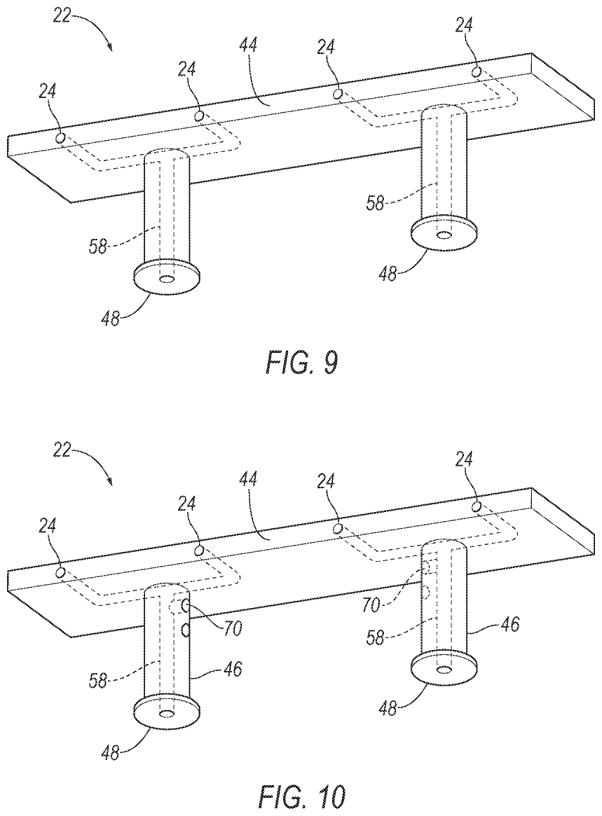

With reference to the Figures, wherein like numerals indicate like parts throughout the several views, a LiDAR sensor 10 includes a casing 12, a window 14 supported by the casing 12, a light detector 16 having a field of view FOV, and a light emitter 18 having a field of illumination FOI aimed at the field of view FOV. At least one of the light detector 16 or the light emitter 18 is in the casing 12 and aimed through the window 14. A fluid line 20 is in the casing 12. A cleaning rail 22 is moveable relative to the casing 12 between a retracted position, as shown in FIGS. 4-5 and 7, and an extended position, as shown in FIGS. 6 and 8. The cleaning rail 22 is slidably received in the fluid line 20 and slidable relative to the fluid line 20 between the retracted position and the extended position. The cleaning rail 22 has nozzles 24 in fluid communication with the fluid line 20. The nozzles 24 are aimed at the window 14 in the extended position. The cleaning rail 22 has a rod 44 slidably received in the fluid line 20 and an arm 46 extending transverse to the rod 44 along the window 14. The arm 46 has the nozzles 24. A light source 72 is on the rod 44. The light source 72 is aimed at the window 14 in the extended position. An image sensor 64 is aimed at the window 14.

With the cleaning rail 22 slidably received by the fluid line 20 between the retracted position and the extended position, fluid pressure in the fluid line 20 urges the cleaning rail 22 toward the extended position. Specifically, fluid pressure in the fluid line 20 above a threshold, as described further below, moves the cleaning rail 22 from the retracted position to the extended position. The fluid pressure may be supplied to the fluid line 20 from an external source, as described below. When the fluid pressure is relieved, the cleaning rail 22 returns to the retracted position, as described further below. Since the cleaning rail 22 has nozzles 24 in fluid communication with the fluid line 20, pressurized fluid in the fluid line 20 flows through the cleaning rail 22 and out of the nozzles 24. The nozzles 24, being aimed at the window 14 in the extended position, directs the fluid at the window 14 for cleaning the window 14. In other words, fluid pressure in the fluid line 20 both moves the cleaning rail 22 to the extended position and emits fluid from the nozzles 24 to clean the window 14. The same fluid that moves the cleaning rail 22 to the extended position is also emitted from the nozzles 24 to clean the window 14.

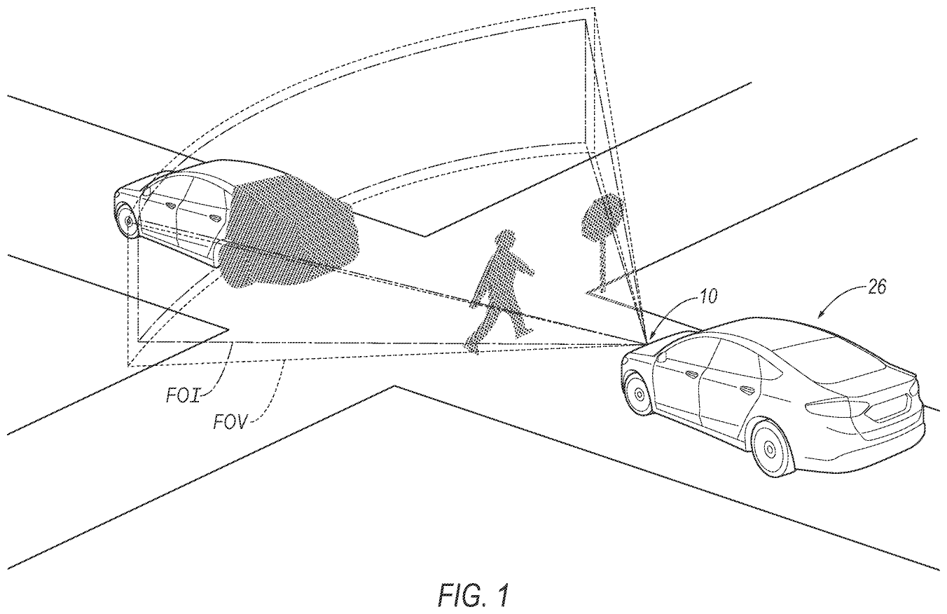

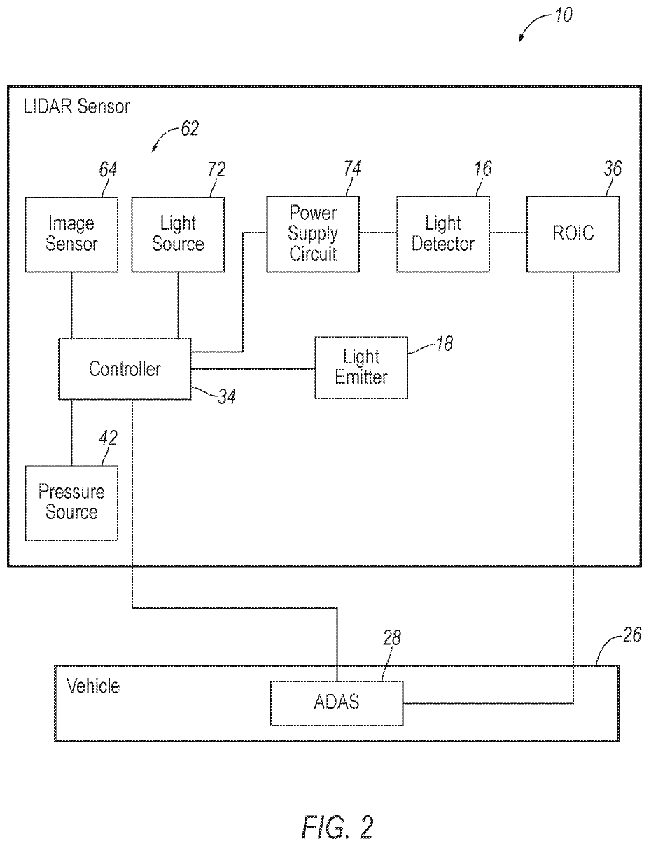

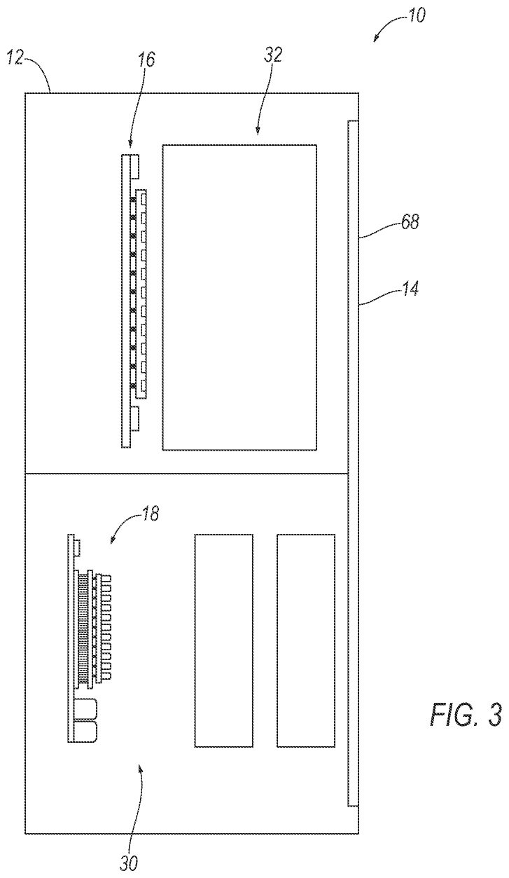

The LiDAR sensor 10 is shown in FIG. 1 as being mounted on a vehicle 26. In such an example, the LiDAR sensor 10 is operated to detect objects in the environment surrounding the vehicle 26 and to detect distance, i.e., range, of those objects for environmental mapping. The output of the LiDAR sensor 10 may be used, for example, to autonomously or semi-autonomously control operation of the vehicle 26, e.g., propulsion, braking, steering, etc. Specifically, the LiDAR sensor 10 may be a component of or in communication with an advanced driver-assistance system (ADAS 28) of the vehicle 26 (FIG. 2). The LiDAR sensor 10 may be mounted on the vehicle 26 in any suitable position and aimed in any suitable direction. As one example, the LiDAR sensor 10 is shown on the front of the vehicle 26 and directed forward. The vehicle 26 may have more than one LiDAR sensor 10. The vehicle 26 shown in the figures is a passenger automobile. As other examples, the vehicle 26 may be of any suitable manned or un-manned type including a plane, satellite, drone, watercraft, etc.

The LiDAR sensor 10 may be a non-scanning sensor. For example, the LiDAR sensor 10 may be a solid-state LiDAR. In such an example, the LiDAR sensor 10 is stationary relative to the vehicle 26 in contrast to a mechanical LiDAR, also called a rotating LiDAR, that rotates 360 degrees. For the solid-state LiDAR sensor, for example, the casing 12 may be fixed relative to the vehicle 26, i.e., does not move relative to the component of the vehicle 26 to which the casing 12 is attached, and components of the LiDAR sensor 10 are supported in the casing 12. As a solid-state LiDAR, the LiDAR sensor 10 may be a flash LiDAR sensor 10. In such an example, the LiDAR sensor 10 emits pulses, i.e., flashes, of light into a field of illumination FOI. More specifically, the LiDAR sensor 10 may be a 3D flash LiDAR sensor that generates a 3D environmental map of the surrounding environment. In a flash LiDAR sensor 10, the FOI illuminates a field of view FOV of the light detector 16. Another example of solid-state LiDAR includes an optical-phase array (OPA). Another example of solid-state LiDAR is a micro-electromechanical system (MEMS) scanning LiDAR, which may also be referred to as a quasi-solid-state LiDAR.

The LiDAR sensor 10 emits infrared light and detects (i.e., with photodetectors) the emitted light that is reflected by an object in the field of view FOV, e.g., pedestrians, street signs, vehicles, etc. Specifically, the LiDAR sensor 10 includes a light-emission system 30, a light-receiving system 32, and a controller 34 that controls the light-emission system 30 and the light-receiving system 32. The LiDAR sensor 10 also detects ambient visible light reflected by an object in the field of view FOV (i.e., with photodetectors).

With reference to FIGS. 4-8, the LiDAR sensor 10 may be a unit. Specifically, the casing 12 supports the light-emission system 30 and the light-receiving system 32. The casing 12 may enclose the light-emission system 30 and the light-receiving system 32. The casing 12 may include mechanical attachment features to attach the casing 12 to the vehicle 26 and electronic connections to connect to and communicate with electronic system of the vehicle 26, e.g., components of the ADAS 28. At least one window 14 is supported by the casing 12. Specifically, the casing 12 includes an aperture and the window 14 extends across the aperture. The casing 12, for example, may be plastic or metal and may protect the other components of the LiDAR sensor 10 from moisture, environmental precipitation, dust, etc. In the alternative to the LiDAR sensor 10 being a unit, components of the LiDAR sensor 10, e.g., the light-emission system 30 and the light-receiving system 32, may be separated and disposed at different locations of the vehicle 26.

With reference to FIG. 2, the light-emission system 30 may include one or more light emitter 18 and optical components such as a lens package, lens crystal, pump delivery optics, etc. The optical components are between the light emitter 18 and the window 14. Thus, light emitted from the light emitter 18 passes through the optical components before exiting the casing 12 through the window 14. The optical components include at least one optical element and may include, for example, a collimating lens, transmission optics, etc. The optical components direct, focus, and/or shape the light into the field of illumination FOI.

The light emitter 18 emits light for illuminating objects for detection. The light-emission system 30 may include a beam-steering device (not shown) between the light emitter 18 and the window 14. The controller 34 is in communication with the light emitter 18 for controlling the emission of light from the light emitter 18 and, in examples including a beam-steering device, the controller 34 is in communication with the beam-steering device for aiming the emission of light from the LiDAR sensor 10 into the field of illumination FOI.

At least one of the light detector 16 or the light emitter 18 is in the casing 12 and aimed through the window 14. In the example shown in the figures, both the light detector 16 and the light emitter 18 are in the casing 12 and aimed through the window 14. In the example shown in the figures, one window 14 is on the casing 12 and the field of illumination FOI and the field of view FOV are both aimed through the window 14. In other examples, two windows 14 may be on the casing 12 with the field of illumination FOI aimed through one of the windows 14 and with the field of view FOV aimed through the other of the windows 14. In such an example, the nozzles 24 on the cleaning rail 22 may be aimed at one or both of the windows 14.

The light emitter 18 emits light into the field of illumination FOI for detection by the light-receiving system 32 when the light is reflected by an object in the field of view FOV. In the example in which the LiDAR sensor 10 is flash LiDAR, the light emitter 18 emits shots, i.e., pulses, of light into the field of illumination FOI for detection by the light-receiving system 32 when the light is reflected by an object in the field of view FOV to return photons to the light-receiving system 32. Specifically, the light emitter 18 emits a series of shots. The light-receiving system 32 has a field of view FOV that overlaps the field of illumination FOI and receives light reflected by surfaces of objects, buildings, road, etc., in the FOV. The light-receiving system 32 has a field of illumination FOI aimed at the field of view FOV. In other words, the light-receiving system 32 detects shots emitted from the light emitter 18 and reflected in the field of view FOV back to the light-receiving system 32, i.e., detected shots. The field of illumination FOI may completely or partially overlap the field of view FOV. The light emitter 18 may be in electrical communication with the controller 34, e.g., to provide the shots in response to commands from the controller 34.

The light emitter 18 may be, for example, a laser. The light emitter 18 may be, for example, a semiconductor light emitter 18, e.g., laser diodes. In one example, the light emitter 18 is a vertical-cavity surface-emitting laser (VCSEL). As another example, the light emitter 18 may be a diode-pumped solid-state laser (DPSSL). As another example, the light emitter 18 may be an edge emitting laser diode. The light emitter 18 may be designed to emit a pulsed flash of light, e.g., a pulsed laser light. Specifically, the light emitter 18, e.g., the VCSEL or DPSSL or edge emitter, is designed to emit a pulsed laser light or train of laser light pulses. In examples in which the first optical element and the second optical element are diffusers, the light emitted by the light emitter 18 is diffused by the first optical element and the second optical, as described above. The light emitted by the light emitter 18 may be, for example, infrared light. Alternatively, the light emitted by the light emitter 18 may be of any suitable wavelength. The LiDAR sensor 10 may include any suitable number of light emitters 18, i.e., one or more in the casing 12. In examples that include more than one light emitter 18, the light emitters 18 may be arranged in a column or in columns and rows. In examples that include more than one light emitter 18, the light emitters 18 may be identical or different and may each be controlled by the controller 34 for operation individually and/or in unison.

The light emitter 18 has a field of illumination FOI aimed at the field of view FOV. As set forth above, the field of view of the light-receiving system 32 overlaps the field of illumination FOI and receives light reflected by objects in the FOV. Stated differently, the field of illumination FOI generated by the light-emitting system overlaps part of or the entire field of view FOV of the light-receiving system 32. The light-receiving system 32 may include receiving optics and a light detector 16 having the array of photodetectors. The receiving optics may be between the window 14 and the light detector 16. The receiving optics may be of any suitable type and size.

The light detector 16 includes a chip and the array of photodetectors is on the chip, as described further below. The chip may be silicon (Si), indium gallium arsenide (InGaAs), germanium (Ge), etc., as is known. The array of photodetectors may be 2-dimensional. Specifically, the array of photodetectors includes a plurality of photodetectors arranged in a columns and rows.

Each photodetector is light sensitive. Specifically, each photodetector detects photons by photo-excitation of electric carriers. An output signal from the photodetector indicates detection of light and may be proportional to the amount of detected light. The output signals of each photodetector are collected to generate a scene detected by the photodetector.

The photodetector may be of any suitable type, e.g., photodiodes (i.e., a semiconductor device having a p-n junction or a p-i-n junction) including avalanche photodiodes (APD), a single-photon avalanche diode (SPAD), a PIN diode, metal-semiconductor-metal photodetectors, phototransistors, photoconductive detectors, phototubes, photomultipliers, etc. The photodetectors may each be of the same type.

The light detector 16 includes a plurality of pixels. Each pixel may include one or more photodetectors. The pixels may each include a power-supply circuit 74 and a read-out integrated circuit (ROIC 36). The photodetectors are connected to the power-supply circuit 74 and the ROIC 36. The light detector 16 detects photons by photo-excitation of electric carriers. An output from the light detector 16 indicates a detection of light and may be proportional to the amount of detected light, in the case of a PIN diode or APD, and may be a digital signal in case of a SPAD. The outputs of light detector 16 are collected to generate a 3D environmental map, e.g., 3D location coordinates of objects and surfaces within the field of view FOV of the LiDAR sensor 10.

The ROIC 36 converts an electrical signal received from photodetectors to digital signals. The ROIC 36 may include electrical components which can convert electrical voltage to digital data. The ROIC 36 may be connected to the controller 34, which receives the data from the ROIC 36 and may generate 3D environmental map based on the data received from the ROIC 36.

The power-supply circuits 74 supply power to the photodetectors. The power-supply circuit 74 may include active electrical components such as MOSFET (Metal-Oxide-Semiconductor Field-Effect Transistor), BiCMOS (Bipolar CMOS), etc., and passive components such as resistors, capacitors, etc. As an example, the power-supply circuit 74 may supply power to the photodetectors in a first voltage range that is higher than a second operating voltage of the ROIC 36. The power-supply circuit 74 may receive timing information from the ROIC 36.

The controller 34 is in electronic communication with the pixels (e.g., with the ROIC 36 and power-supply circuit 74) and the vehicle 26 (e.g., with the ADAS 28) to receive data and transmit commands. The controller 34 may be configured to execute operations disclosed herein. The controller 34 is a physical, i.e., structural, component of the LiDAR sensor 10. The controller 34 may be a microprocessor-based controller 34, an application specific integrated circuit (ASIC), field programmable gate array (FPGA), etc., or a combination thereof, implemented via circuits, chips, and/or other electronic components.

The LiDAR sensor 10 includes a window-cleaning system 38. The window-cleaning system 38 includes the fluid line 20 and the cleaning rail 22 and may include a spring 40. The cleaning rail 22 is slidably received in the fluid line 20 such that pressurized fluid in the fluid line 20, e.g., from a pressure source 42, both moves the cleaning rail 22 from the retracted position to the extended position and also exits the cleaning rail 22 through the nozzles 24 to clean the window 14 on an exterior of the LiDAR sensor 10. As set forth below, the pressure source 42 may be external to the LiDAR sensor 10 to pressurize fluid in the fluid line 20 to clean the window 14. In the example shown in the figures, the window-cleaning system 38 includes the spring 40 and the spring 40 biases the cleaning rail 22 toward the retracted position. Pressure in the fluid line 20 that exceeds the spring force of the spring 40 moves the cleaning rail 22 to the extended position, as described further below.

The cleaning rail 22 may have a rod 44 and an arm 46 extending transverse to the rod 44. The rod 44 and the rail move together as a unit relative to the fluid line 20 and the casing 12 between the retracted position and the extended position. The arm 46 is fixed relative to the rod 44. As an example, the rod 44 and the arm 46 may be adhered to each other, bonded to each other, fastened to each other, etc. As another example, the rod 44 and the arm 46 may be unitary, i.e., a single, uniform piece of material with no seams, joints, fasteners, or adhesives holding it together that is formed together simultaneously as a single continuous unit, e.g., by machining from a unitary blank, molding, casting, etc. The rod 44 and the arm 46 may be plastic, metal, combinations thereof, etc.

The cleaning rail 22 may include any suitable number of rods 44. In the example shown in the figures, the cleaning rail 22 includes two rods 44, i.e., a first rod and a second rod. In such an example, the arm 46 extends from one of the rods 44 to the other of the rods 44. Said differently, the arm 46 bridges the two rods 44 and moves together as a unit with the two rods 44. In examples including more than one rod 44, the rods 44 may be similar or identical. Both rods 44 may feed pressurized fluid to nozzles 24 on the arm 46. In the example shown in the figures, the window-cleaning system 38 includes two fluid lines 20, i.e., a first fluid line and a second fluid line, with one of the rods 44 slidably received in one of the fluid lines 20 and the other of the rods 44 slidably received in the other of the fluid lines 20. In such an example, both fluid lines 20 feed pressurized fluid to the respective nozzles 24. In other examples, a single fluid line 20 may include separate branches in which the rods 44 are slidably received such that pressurization in the single fluid line 20 moves both rods 44 to the extended position and feeds all nozzles 24.

The cleaning rail 22 is moveable relative to the casing 12 between the retracted position and the extended position. In the example shown in the figures, the rod 44 extends into the fluid line 20 and the arm 46 extends transverse to the rod 44 external to the fluid line 20. The rod 44 and the arm 46 slide relative to the fluid line 20 and the casing 12 between the retracted position and the extended position. Specifically, the rod 44 slides out of the fluid line 20 from the retracted position and the extended position and the rod 44 slides into the fluid line 20 from the extended position to the retracted position. The arm 46 moves with the rod 44 as the rod 44 slides into and out of the fluid line 20. The arm 46 moves toward the casing 12 from the extended position to the retracted position and the arm 46 moves away from the casing 12 from the retracted position to the extended position. The arm 46 may abut the casing 12 in the retracted position. The arm 46 may be spaced from the casing 12 in the extended position to position the nozzles 24 to be aimed at the window 14 for cleaning the window 14.

The cleaning rail 22 is supported by the casing 12, i.e., the weight of the cleaning rail 22 is borne by the casing 12. The cleaning rail 22 may be supported directly by the casing 12 or indirectly by the casing 12. In the example shown in the figures, the cleaning rail 22 is supported by the fluid line 20, which is supported by the casing 12, i.e., the cleaning rail 22 is indirectly supported by the casing 12.

As set forth above, the cleaning rail 22 is slidably engaged with the fluid line 20. In the example shown in the figures, the cleaning rail 22 is slidably received in the fluid line 20. Specifically, in the example shown in the figures, the rod 44 of the cleaning rail 22 is slidably received in the fluid line 20. In other examples, the fluid line 20 may be slidably received in the rod 44. With reference to the example in the figures, for example, at least a portion of the fluid line 20 may be straight and that portion of the fluid line 20 and the rod 44 may be coaxial and sized such that the rod 44 extends into and slides in the fluid line 20. As shown in the example shown in the figures, the rod 44 may include a flange 48 that slides along an inner wall 50 of the fluid line 20. The flange 48 may abut the inner wall 50 and/or may include a seal that abuts the inner wall 50. In such examples, flange 48 (and/or the seal in examples including the seal) prevents fluid communication between the flange 48 and the inner wall 50 such that fluid pressure in the fluid line 20, e.g., generated from the pressure source 42, biases the flange 48 toward the extended position. The flange 48 and/or the seal may be of suitable material to fluidly seal between the flange 48 and the inner wall 50, e.g., a polymeric material such as rubber. The fluid line 20 and the rod 44 may be circular in cross-section, as shown in the example in the figures. The fluid line 20 may be any suitable material for holding and transmitting pressurized fluid therein and for interacting with the rod 44 during movement between the retracted and extended positions. The fluid line 20, for example, may be polymeric (e.g., plastic), metal, etc.

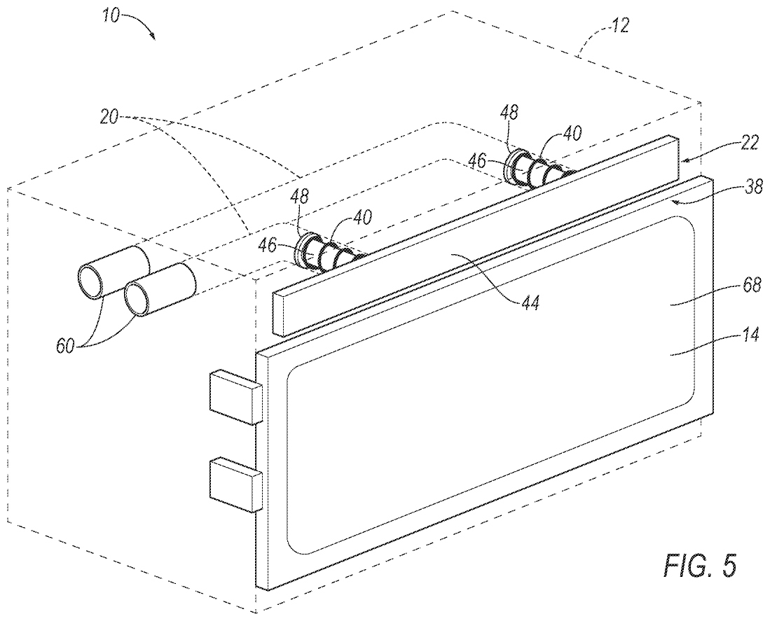

The rod 44 is retained in the fluid line 20 such that the rod 44 is moveable relative to the fluid line 20 between the retracted position and the extended position and remains engaged with the fluid line 20 at and between the retracted position and the extended position. The fluid line 20, the casing 12, the rod 44, and/or the arm 46 may include features for retaining the cleaning rail 22 in the fluid line 20. As an example, as shown in FIGS. 5-8, the fluid line 20 includes an orifice 52 at the casing 12 and the flange 48 retains the rod 44 in the orifice 52 at the extended position. Specifically, the orifice 52 may have a smaller cross-sectional shape than the flange 48, e.g., at a ledge 54, so that orifice 52 prevents movement of the flange 48 past the orifice 52 at the extended position, e.g., when the fluid line 20 is pressurized at a pressure that exceeds the spring force of the spring 40.

The arm 46 may abut the casing 12 to stop the cleaning rail 22 at the retracted position. In other words, the spring 40 biases the rod 44 toward the retracted position and the abutment of the arm 46 with the casing 12 stops the cleaning rail 22 at the retracted position against the bias of the spring 40. The casing 12 may include a pocket 56 that receives the arm 46 in the retracted position. Specifically, the arm 46 recesses into the pocket 56 in the retracted position. Outer surfaces of the arm 46 and the casing 12 may be flush around the arm 46 in the retracted position.

The cleaning rail 22 may be biased toward the retracted position in the absence of fluid pressure in the fluid line 20 exceeding a threshold. In the example shown in the figures, the window-cleaning system 38 includes a spring 40 (and more specifically two springs 40, one on each rod 44) that bias the cleaning rail 22 toward the retracted position. The spring 40 may be retained between the fluid line 20 and the rod 44. In the example shown in the figures, the spring 40 is retained between the flange 48 of the rod 44 and the ledge 54 of the fluid line 20. In the example shown in the figures, the spring 40 is a coil spring and extends helically around the rod 44.

The spring 40 has a spring constant. The fluid line 20 may be pressurized, e.g., by the pressure source 42 described below, to a pressure greater than the spring constant to compress the spring 40 and move the cleaning rail 22 to the extended position.

As set forth above, the cleaning rail 22 has nozzles 24 in fluid communication with the fluid line 20. In the example shown in the figures, the rod 44 defines a bore 58 in fluid communication with the fluid line 20 and in fluid communication with the nozzles 24. The bore 58 extends through both the rod 44 and arm 46 from the fluid line 20 to the nozzles 24.

The nozzles 24 may be on the arm 46, as shown in the example in the figures. The arm 46 may have any suitable number of nozzles 24. Each of the nozzles 24 are in fluid communication with the bore 58. The nozzles 24 are smaller than the bore 58 so that fluid pressure in the fluid line 20 supplied by the pressure source 42 builds in the fluid line 20 while some of the fluid pressure in the pressure line dissipates through the nozzles 24. The nozzles 24 are designed, e.g., sized, shaped, positioned, such that the fluid line 20 is pressurized when the pressure source 42 provides pressurized fluid to the fluid line 20 during movement of the cleaning rail 22 from the retracted position to the extended position and during emission of the pressurized fluid from the nozzles 24, i.e., to clean the window 14.

The nozzles 24 are aimed at the window 14 in the extended position. In other words, the nozzles 24 are sized, shaped, and positioned so that pressurized fluid in the fluid line 20 and the bore 58 is emitted from the nozzles 24 and onto the window 14 to clean an exterior surface of the window 14. The arm 46 extends along the window 14 in the extended position. In other words, in the extended position, the arm 46 is spaced from the window 14 with nothing therebetween such that pressurized fluid from the nozzle 24 is emitted onto the window 14. The nozzles 24, for example, may be aimed at a portion of the window 14 in a field-of-view of a vision system 62, e.g., an image sensor 64 of the vision system 62.

The fluid line 20 is in the casing 12. The fluid line 20 may include, for example, a port 60 for connection to the pressure source 42. The fluid line 20 may extend continuously and uninterrupted from the port to the orifice 52. As set forth above, the fluid line 20, for example, may be polymeric (e.g., plastic), metal, etc.

As set forth above, the pressure source 42 may be external to the casing 12. The pressure source 42 may be in fluid communication with the fluid line 20 through the port 60, as an example. The pressure source 42 provides pressurized fluid to the fluid line 20. The controller 34 controls operation of the pressure source 42 to selectively provide pressurized fluid to the fluid line 20 to move the cleaning rail 22 to the extended position and emit the pressurized fluid from the nozzles 24. The pressure source 42 may be a source of compressed air, e.g., an air compressor including those that are known. In such an example, the fluid line 20, the bore 58, and the nozzles 24 are designed such that pressurized air in the fluid line 20 from the pressure source 42 above the spring force of the spring 40 moves the cleaning rail 22 to the extended position and the pressurized air is emitted from the nozzles 24 onto the window 14. In other examples, the pressure source 42 may be a source of liquid, e.g., water, cleaning liquid, etc. In such an example, the fluid line 20, the bore 58, and the nozzles 24 are designed such that the liquid provided by the pressure source 42 pressurizes the fluid line 20 to a pressure above the spring force of the spring 40 to move the cleaning rail 22 to the extended position and exit the nozzles 24 onto the window 14.

The LiDAR sensor 10 may have a vision system 62 for viewing and identifying obstructions on the window 14 that may be cleaned, e.g., dirt, dust, condensation, frost, etc. Examples of the vision system 62 are shown in FIGS. 2 and 11-13. The vision system 62 may, for example, include an image sensor 64 aimed at the window 14. The image sensor 64 may be one or more cameras, CCD image sensors, CMOS image sensors, etc.

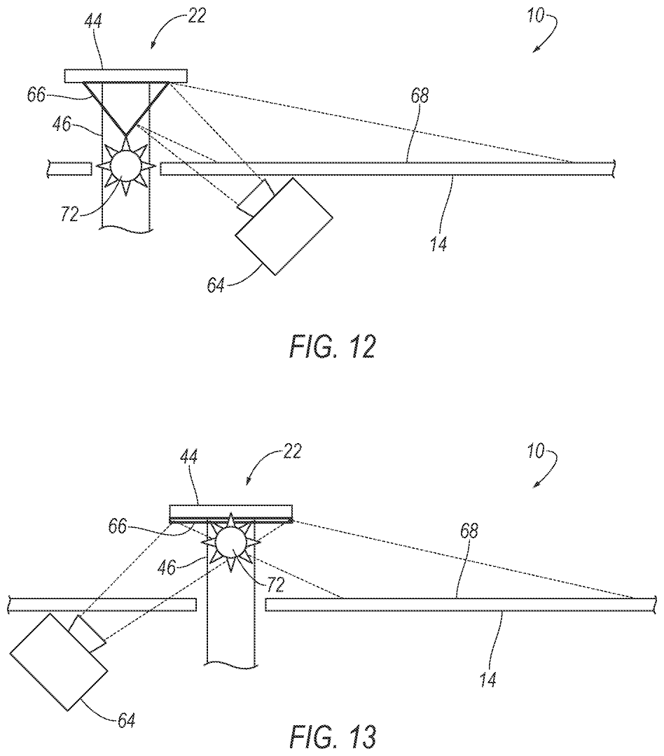

As one example, as shown in FIGS. 12 and 13, the image sensor 64 may be in the casing 12 and aimed at the window 14. In the examples shown in FIGS. 12 and 13, the image sensor 64 is aimed indirectly at the window 14 with the use of a mirror 66. Specifically, image sensor 64 and the mirror 66 are designed, i.e., sized, shaped, and positioned, so that image sensor 64 is aimed at an exterior side 68 of the window 14 through the reflection of the mirror 66. In example shown in FIG. 12, the image sensor 64 is below the window 14 and the mirror 66 has an angled surface to reflect the exterior side 68 of the window 14 to the image sensor 64. In the example shown in FIG. 13, the image sensor 64 is on an opposite side of the mirror 66 from the window 14 and the mirror 66 has a flat surface to reflect the exterior side 68 of the window 14 to the image sensor 64. As another example, the image sensor 64 may be aimed directly at an interior side of the window 14 to detect material on an exterior side 68 of the window 14 to be cleaned.

In the examples shown in FIGS. 12 and 13, the mirror 66 is fixed to and moves as a unit with the arm 46. The mirror 66 is positioned to reflect an image of the exterior side 68 of the window 14 to the image sensor 64 when the cleaning rail 22 is in the extended position.

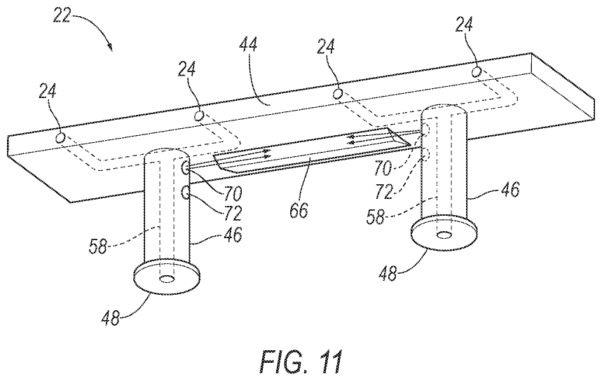

The vision system 62 may include features to illuminate and/or clean the window 14 and/or the mirror 66 to ensure accurate reflection of the window 14 to the image sensor 64. In the example shown in FIG. 11, the cleaning rail 22 includes another nozzle 70 on the rod 44. The nozzle 70 is aimed at the window 14 and the mirror 66 in the extended position to emit compressed fluid from the bore 58 to clean the window 14 and the mirror 66. As shown in FIG. 11, the nozzle 70 is in fluid communication with fluid line 20 through the bore 58.

In the examples shown in FIGS. 11-13, a light source 72 is on the rod 44. The light source 72 is aimed at the window 14 in the extended position. The light source 72 illuminates the window 14 to aid in identification of areas of the window 14 that needs cleaning. The light source 72 moves with the rod 44 between the extended position and retracted position. The light source 72 may be of any suitable type, e.g., a light-emitting diode (LED). The light source 72 may have a power source in the cleaning rail 22 or external to the cleaning rail 22. The controller 34 may control operation of the light source 72. The controller 34 may be in communication with the light source 72 in any suitable way such as wireless or wired connection.

In operation, the LiDAR sensor 10 controls operation of the window-cleaning system 38. As one example, the controller 34 of the LiDAR sensor 10, as described above, may control the window-cleaning system 38. The controller 34 may activate the window-cleaning system 38 based on detection of condition to clean the window 14 and/or may activate the window-cleaning system 38 periodically. In either example, the controller 34 may receive feedback, e.g., from the image sensor 64, and may control the duration of operation of the window-cleaning system 38 based on detection of conditions of the window 14 that need cleaning and/or absence thereof.

The controller 34 operates the window-cleaning system 38 by commanding activation of the pressure source 42. In response to command from the controller 34, the pressure source 42 pressurizes the fluid line 20, e.g., with air or liquid a described above, to a pressure above the spring constant of the spring 40 such that the cleaning rail 22 moves from the retracted position to the extended position and pressurized fluid is emitted from the nozzles 24 onto the window 14. In examples in which the pressure source 42 pressurizes the fluid line 20 with liquid, the controller 34 may disable image detection by the LiDAR sensor 10 to avoid image distortion while liquid is on the window 14.

In examples including the light source 72, while the pressure source 42 pressurizes the fluid line 20 so that the cleaning rail 22 is in the extended position, the controller 34 may command the light source 72 to illuminate the exterior side 68 of the window 14 and/or the mirror 66 in examples including the light source 72. In examples including image sensor 64, while the pressure source 42 pressurizes the fluid line 20 so that the cleaning rail 22 is in the extended position, the controller 34 may command the image sensor 64 to capture images of the exterior side 68 of the window 14. In the event the images indicate that the exterior side 68 of the window 14 is in a condition that could benefit from additional cleaning, the controller 34 may command the pressure source 42 to continue operation in response to the detected images. The controller 34 may disable image detection by the LiDAR sensor 10 to avoid image distortion and, as set forth above, in examples in which the pressure source 42 pressurizes the fluid line 20 with liquid, the controller 34 may disable image detection by the LiDAR sensor 10 to avoid image distortion while liquid is on the window 14. In the event the images indicate that the exterior side 68 of the window 14 is clean, the controller 34 may command deactivation of the pressure source 42 in response to the detected images. The controller 34 may include image processing software, including that which is currently known, to identify the condition of the exterior side 68 of the window 14.

The disclosure has been described in an illustrative manner, and it is to be understood that the terminology which has been used is intended to be in the nature of words of description rather than of limitation. Use of numerical adjectives including “first,” “second,” etc., are identifiers and do not indicate order or importance. Many modifications and variations of the present disclosure are possible in light of the above teachings, and the disclosure may be practiced otherwise than as specifically described.

What is claimed is:

1. A lidar sensor comprising:
a casing;
a window supported by the casing;
a light detector having a field of view;
a light emitter having a field of illumination aimed at the field of view;
at least one of the light detector or the light emitter being in the casing and aimed through the window;
a fluid line in the casing;
a cleaning rail supported by the casing and moveable relative to the casing between a retracted position and an extended position;
the cleaning rail being slidably received in the fluid line and slidable relative to the fluid line between the retracted position and the extended position;
the cleaning rail having nozzles in fluid communication with the fluid line, the nozzles being aimed at the window in the extended position;
the cleaning rail having a rod slidably received in the fluid line and an arm extending transverse to the rod along the window, the arm having the nozzles;
a light source on the rod, the light source being aimed at the window in the extended position; and
an image sensor aimed at the window.

2. The LiDAR sensor as set forth in claim 1, wherein the rod defines a bore in fluid communication with the nozzles and in fluid communication with the nozzles.

3. The LiDAR sensor as set forth in claim 1, wherein the rod and a portion of the fluid line receiving the rod are coaxial.

4. The LiDAR sensor as set forth in claim 1, further comprising a spring between the rod and the fluid line, the spring biasing the cleaning rail toward the retracted position.

5. The LiDAR sensor as set forth in claim 1, further comprising another nozzle on the rod and aimed at the window in the extended position.

6. The LiDAR sensor as set forth in claim 1, further comprising a second fluid line in the casing, the cleaning rail including a second rod slidably received in the fluid line, the arm extending from the rod to the second rod.

7. The LiDAR sensor as set forth in claim 1, wherein the image sensor is in the casing.

8. The LiDAR sensor as set forth in claim 1, wherein the image sensor is in the casing, the cleaning rail includes a mirror on the arm, and the image sensor is aimed at the mirror in the extended position.

9. The LiDAR sensor as set forth in claim 8, wherein the cleaning rail has a rod slidably received in the fluid line and the rod has another nozzle aimed at the mirror.

10. The LiDAR sensor as set forth in claim 8, wherein the cleaning rail has a rod slidably received in the fluid line and the rod has a light source aimed at the mirror.

11. The LiDAR sensor as set forth in claim 1, further comprising a spring between the cleaning rail and the fluid line, the spring biasing the cleaning rail toward the retracted position.

12. The LiDAR sensor as set forth in claim 1, wherein the light detector is in the casing and the field of view is aimed through the window.

13. The LiDAR sensor as set forth in claim 1, wherein the fluid line and nozzles are designed to transmit compressed air.

14. The LiDAR sensor as set forth in claim 1, wherein the fluid line and nozzles are designed to transmit liquid.
